(19) United States
(12) Patent Application Publication
(10) Pub. No.: US 2026/0122005 A1
(43) Pub. Date: Apr. 30, 2026

(54) PACKET SWITCH CAPABLE OF DISTINGUISHING DIFFERENT NETWORK CONNECTIONS AND OFFERING SPECIFIC SOFTWARE-DEFINED PACKET OFFLOAD PROCESSING FLOW AND ASSOCIATED PACKET FORWARDING METHOD

(71) Applicant: MEDIATEK INC., Hsichu City (TW)

(72) Inventors: Chun-Te Wu, Hsinchu City (TW); Wen-Tsung Chung, Hsinchu City (TW); Wei-Cyuan Wu, Hsinchu City (TW); Sheng-Yun Wu, Hsinchu City (TW)

(73) Assignee: MEDIATEK INC., Hsinchu City (TW)

(21) Appl. No.: 19/291,618

(22) Filed: Aug. 6, 2025

Related U.S. Application Data
(60) Provisional application No. 63/686,894, filed on Aug. 26, 2024.

(51) Int. Cl. H04L 49/111

(52) U.S. Cl. CPC H04L 49/111

(57) ABSTRACT

A packet switch includes: multiple ports, wherein the multiple ports include an input port, multiple intermediate ports, and an output port, and a packet is received via the input port; multiple enqueue modules, arranged to forward the packet to at least one of the multiple intermediate ports and the output port according to a through-port (T-port) table and a T-port index, wherein the packet carries the T-port index, and the multiple enqueue modules correspond to the input port and the multiple intermediate ports, respectively.

### CROSS REFERENCE TO RELATED APPLICATIONS

This application claims the benefit of U.S. Provisional Application No. 63/686,894, filed on Aug. 26, 2024. The content of the application is incorporated herein by reference.

### BACKGROUND

The present invention is related to packet offload processing, and more particularly, to a packet switch capable of distinguishing different network connections offering and a specific software-defined packet offload processing flow, and an associated packet forwarding method.

For an existing packet offload processing flow, pipeline architecture is commonly adopted, wherein multiple hardware offload engines sequentially perform different offload operations upon a packet, and a dedicated packet first in first out (FIFO) buffer is set between each two of the multiple hardware offload engines for providing pipeline storage. For example, in a pipeline-based packet offload processing flow, an additional multiplexer (MUX) circuit can be coupled to a hardware offload engine in order to selectively perform offload processing upon a packet via the hardware offload engine. In another example, an additional bypass path may exist within a hardware offload engine for allowing a packet to be bypassed to the subsequent packet FIFO buffer when offload processing of the hardware offload engine is not required to be performed upon the packet. Some problems may occur, however. The MUX circuit may cause additional costs. If a packet needs to be processed by the same hardware offload engine twice, the packet may need to be sent back to a reception starting point, resulting in double the latency.

### SUMMARY

It is therefore one of the objectives of the present invention to provide a packet switch that can perform packet forwarding according to a through-port (T-port) index carried by a packet and a T-port table, and an associated packet forwarding method, in order to address the above-mentioned issues.

According to an embodiment of the present invention, a packet switch is provided, wherein the packet switch comprises multiple ports and multiple enqueue modules. The multiple ports comprise an input port, multiple intermediate ports, and an output port, and a packet is received via the input port. The multiple enqueue modules are arranged to forward the packet to at least one of the multiple intermediate ports and the output port according to a T-port table and a T-port index, wherein the packet carries the T-port index, and the multiple enqueue modules correspond to the input port and the multiple intermediate ports, respectively.

According to an embodiment of the present invention, a packet forwarding method is provided, wherein the packet forwarding method is performed by a packet switch; the packet switch comprises multiple ports, and multiple enqueue modules; the multiple ports comprise an input port, multiple intermediate ports, and an output port; and the multiple enqueue modules correspond to the input port and the multiple intermediate ports, respectively. The packet forwarding method comprises: receiving a packet via the input port; forwarding, by the multiple enqueue modules, the packet to one of the multiple intermediate ports and the output port according to a through-port (T-port) table and a T-port index, wherein the packet carries the T-port index, and the multiple enqueue modules correspond to the input port and the multiple intermediate ports, respectively.

One of the benefits of the present invention is that, by the packet switch and the associated packet forwarding method proposed by the present invention, a T-port index can be assigned to a received packet via a software-defined T-port, and multiple enqueue modules can determine a forwarding path of the packet according to the T-port index and a T-port table, for performing necessary offloading processing. Compared to a pipeline-based offloading solution, the packet switch of the present invention can save the costs associated with additional MUX circuits, and can improve the latency issues caused by bypass paths.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a packet switch according to an embodiment of the present invention.

FIG. 3 is a diagram illustrating an example of packet forwarding performed by the packet switch shown in FIG. 2 according to an embodiment of the present invention.

FIG. 4 is a diagram illustrating an example of the T-port table shown in FIG. 2 according to an embodiment of the present invention.

FIG. 5 is a diagram illustrating utilizing multiple packet switches to perform packet forwarding according to an embodiment of the present invention.

FIG. 6 is a diagram illustrating utilizing multiple packet switches to perform packet forwarding according to another embodiment of the present invention.

FIG. 7 is a flow chart of a packet forwarding method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

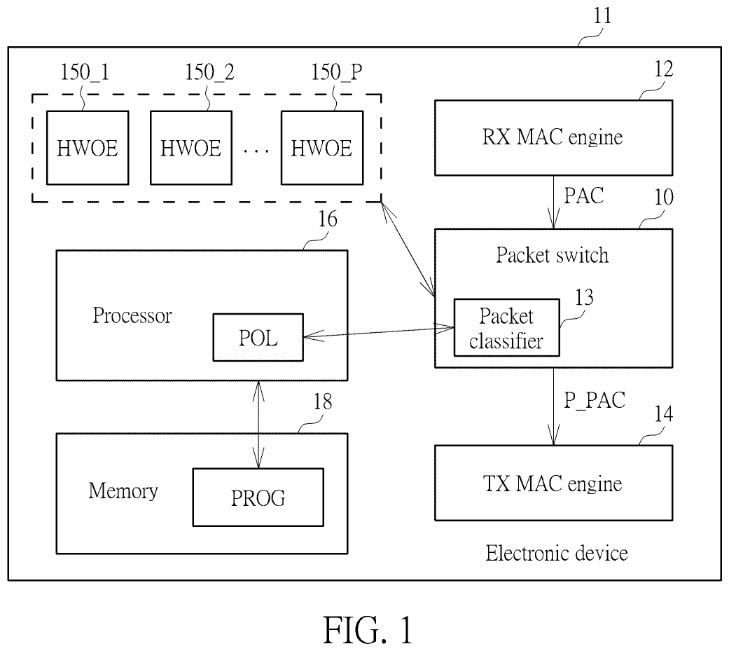

FIG. 1 is a diagram illustrating an electronic device 11 according to an embodiment of the present invention. As shown in FIG. 1, the electronic device 11 may include a packet switch 10, a reception (RX) media access control (MAC) engine 12, a transmission (TX) MAC engine 14, a processor 16, a memory 18, and multiple hardware offload engines 150_1-150_p (for brevity, labeled as “HWOE” in FIG. 1, respectively), wherein “p” is a positive integer greater than one. Examples of the electronic device 11 may include, but are not limited to: a router, a switch, and a network interface card (NIC). Examples of the hardware offload engines 150_1-150_p may include, but are not limited to: a checksum offload engine, a network address translation (NAT) offload engine, a tunnel offload engine, a virtual private network (VPN) offload engine, and a quality of service (QoS) offload engine. Since the offload processing of the above-mentioned hardware offload engines is well known to those skilled in the art, further descriptions are omitted here for brevity.

The packet switch 10 may receive a packet PAC from the reception MAC engine 12, and forward the packet PAC to the hardware offload engines 150_1-150_p according to some information carried by the packet PAC, in order to offload packet processing tasks originally handled by the processor 16 to the hardware offload engines 150_1-150_p. In this way, the burden on the processor 16 can be reduced and the overall packet processing speed can be improved.

The memory 18 may be a non-transitory machine-readable medium, and may be arranged to store computer program code PROG. When loaded and executed by the processor 16, the program code PROG may instruct the processor 16 to define a policy POL. The packet switch 10 may include a packet classifier 13 implemented by hardware. The packet classifier 13 may be arranged to define at least one throughput port (T-port; hereinafter refer to as “SW T-port”) according to the policy POL from the processor 16, and assign a T-port index PAC_IDX to the packet PAC via the at least one SW T-port, wherein the T-port index PAC_IDX may be associated to offload processing flow of the packet PAC. That is, by adjusting the T-port index PAC_IDX, the forwarding path of the packet PAC can be controlled. For example, the at least one SW T-port may be located at an input port of the packet switch 10, but the present invention is not limited thereto. In some embodiments, the at least one SW T-port may also located at any port of the packet switch 10 except the input port and an output port, in order to adjust the T-port index PAC_IDX carried by the packet PAC during the packet forwarding process.

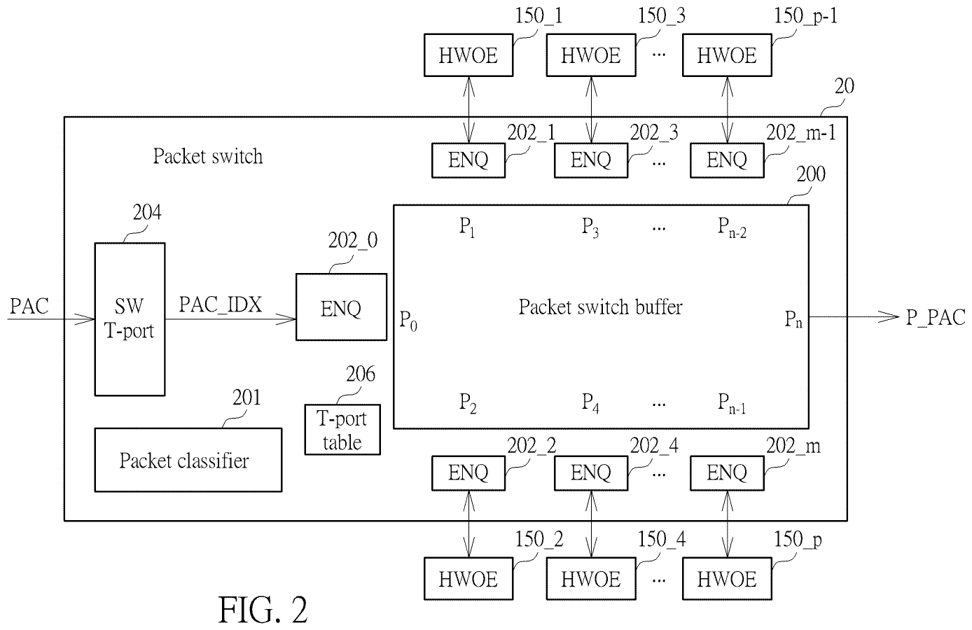

FIG. 2 is a diagram illustrating a packet switch 20 according to an embodiment of the present invention, wherein the packet switch 10 shown in FIG. 1 may be implemented by the packet switch 20. As shown in FIG. 2, the packet switch 20 has multiple ports P₀-Pₙ, and includes a packet switch buffer 200, a packet classifier 201, and multiple enqueue modules 202_0-202_m, wherein each of “n” and “m” is an positive integer, the port P₀ may be regarded as an input port, the ports P₁-Pₙ₋₁ may be regarded as multiple intermediate ports, and the port Pₙ may be regarded as an output port. The enqueue modules 202_0-202_m may be implemented by software and/or hardware (e.g., circuits), and the number of enqueue modules 202_0-202_m may be equal to the number of ports P₀-Pₙ minus one (i.e., m=n−1).

In this embodiment, the packet classifier 201 may define a SW T-port 204 according to the policy POL from the processor 16 shown in FIG. 1, and assign the T-port index PAC_IDX to the packet PAC via the SW T-port 204 (i.e., the packet PAC may carry the T-port index PAC_IDX). The ports P₁-Pₙ₋₁ may correspond to the hardware offload engines 150_1-150_p, respectively, wherein the number of hardware offload engines 150_1-150_p is equal to the number of ports P₀-Pₙ minus two (i.e., p=n−1). The enqueue modules 202_0-202_m may correspond to the ports P₀-Pₙ₋₁, respectively. The packet switch 20 may further include a T-port table 206, wherein for each of the ports P₀-Pₙ₋₁, the T-port table 206 records a mapping relationship between the T-port index PAC_IDX and a next port to which the packet PAC is forwarded, and the T-port table 206 may be shared with all of the enqueue modules 202_0-202_m. That is, each of the enqueue modules 202_0-202_m may determine the next port to which the packet PAC is forwarded according to the T-port table 206 and the T-port index PAC_IDX carried by the packet PAC. The packet switch buffer 200 may be arranged to store the packet PAC each time the packet PAC is forwarded. The packet switch 20 may output a final processed packet P_PAC via the output port (i.e., the port Pₙ).

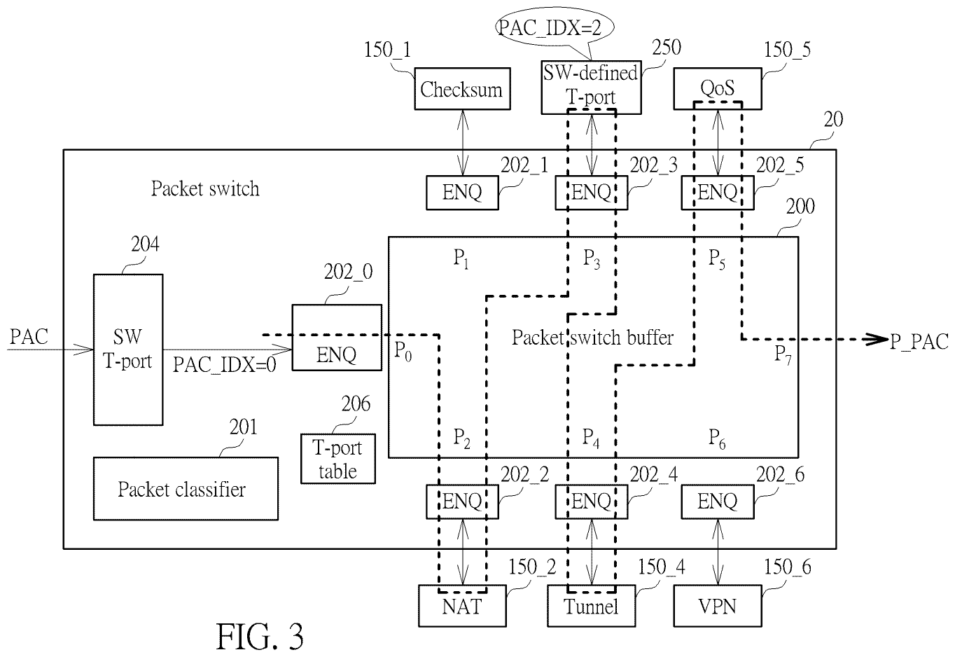

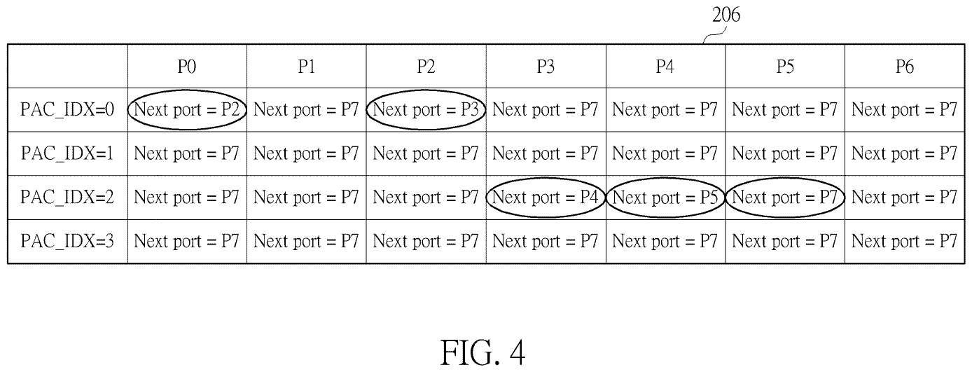

Refer to FIG. 3 in conjunction with FIG. 4. FIG. 3 is a diagram illustrating an example of packet forwarding performed by the packet switch 20 shown in FIG. 2 according to an embodiment of the present invention, wherein a dotted line represents a forwarding path of the packet PAC. FIG. 4 is a diagram illustrating an example of the T-port table 206 shown in FIG. 2 according to an embodiment of the present invention. As shown in FIG. 3, the packet switch 20 has multiple ports P₀-P₇ (i.e., n=7), and includes the packet switch buffer 200, the processor 201, and multiple enqueue modules 202_0-202_6 (i.e., m=6). Hardware offload engines 150_1, 150_2, 150_4, 150_5, and 150_6 may be a checksum offload engine, a NAT offload engine, a tunnel offload engine, a Qos offload engine, and a VPN offload engine, respectively (labeled as “Checksum”, “NAT”, “Tunnel”, “Qos”, and “VPN” in FIG. 3, respectively). In this embodiment, the enqueue module 202_1 may correspond to the hardware offload engine 150_1, the enqueue module 202_2 may correspond to the hardware offload engine 150_2, the enqueue module 202_4 may correspond to the hardware offload engine 150_4, the enqueue module 202_5 may correspond to the hardware offload engine 150_5, and the enqueue module 202_6 may correspond to the hardware offload engine 150_6. It should be noted that, another packet classifier included in the packet switch 20 may further define a SW T-port 250 according to another policy from the processor 16 shown in FIG. 1, wherein the SW T-port 250 may be located at the port P3 and may correspond to the enqueue module 202_3. During the packet forwarding process, in response to the packet PAC being forwarding to the port P₃, the value of the T-port index PAC_IDX carried by the packet PAC can be adjusted via the SW T-port 250.

In the beginning, via the SW T-port 204, the T-port index PAC_IDX with a value “0” may be assigned to the packet PAC (labeled as “PAC_IDX=0” in FIG. 3). At the port P₀, the enqueue module 202_0 may forward the packet PAC to the port P₂ according to the T-port table 206 shown in FIG. 4 and the T-port index PAC_IDX with the value “0”. The hardware offload engine 150_2 may fetch the packet PAC from the packet switch buffer 200 to perform offload processing upon the packet PAC, and then store the processed packet PAC in the packet switch buffer 200 after the offload processing is completed. In response to the packet PAC being stored in the packet switch buffer 200 via the port P₂, the enqueue module 202_2 may forward the packet PAC to the port P₃ according to the T-port table 206 shown in FIG. 4 and the T-port index PAC_IDX with the value “0”. By the SW T-port 250, the value of the T-port index PAC_IDX may be changed from “0” to “2” (labeled as “PAC_IDX=2” in FIG. 3), and then the packet PAC may be stored in the packet switch buffer 200.

In response to the packet PAC being stored in the packet switch buffer 200 via the port P₃, the enqueue module 202_3 may forward the packet PAC to the port P₄ according to the T-port table 206 shown in FIG. 4 and the T-port index PAC_IDX with the value “2”. The hardware offload engine 150_4 may fetch the packet PAC from the packet switch buffer 200 to perform offload processing upon the packet PAC, and then store the processed packet PAC in the packet switch buffer 200 after the offload processing is completed. In response to the packet PAC being stored in the packet switch buffer 200 via the port P₄, the enqueue module 202_4 may forward the packet PAC to the port P₅ according to the T-port table 206 shown in FIG. 4 and the T-port index PAC_IDX with the value “2”. The hardware offload engine 150_5 may fetch the packet PAC from the packet switch buffer 200 to perform offload processing upon the packet PAC, and then store the processed packet PAC in the packet switch buffer 200 after the offload processing is completed. In response to the packet PAC being stored in the packet switch buffer 200 via the port P₅, the enqueue module 202_5 may forward the packet PAC to the port P₇ according to the T-port table 206 shown in FIG. 4 and the T-port index PAC_IDX with the value “2”, in order to output the final processed packet P_PAC via the port P₇.

It should be noted that if the value of the T-port index PAC_IDX was not changed by the SW T-port 250 and remained to be “0”, the next port will be the port P₇ according to the T-port table 206 shown in FIG. 4 and the T-port index PAC_IDX with the value “0”.

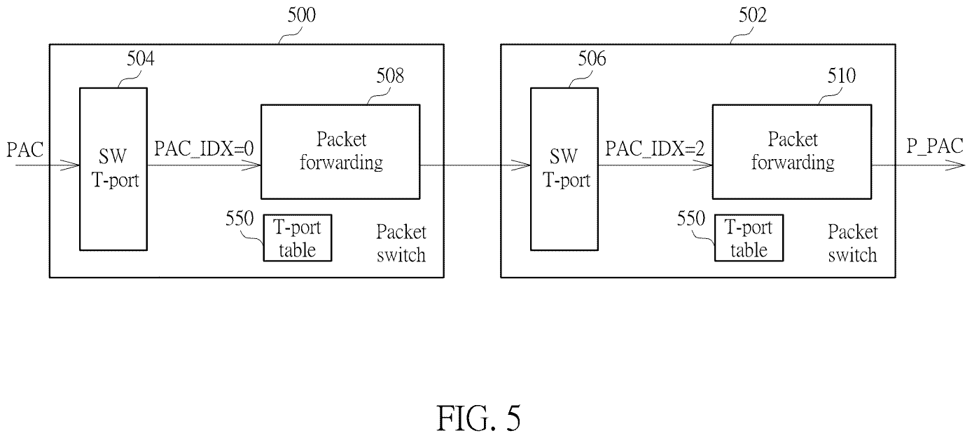

FIG. 5 is a diagram illustrating utilizing multiple packet switches 500 and 502 to perform packet forwarding according to an embodiment of the present invention, wherein each of the packet switches 500 and 502 may be implemented by the packet switches 20 shown in FIG. 2. In this embodiment, after the packet PAC is forwarded by the packet switch 500, the packet PAC is further forwarded by the packet switch 502 for outputting the final processed packet P_PAC via an output port of the packet switch 502. In addition, the same T-port table 550 is shared between the packet switches 500 and 502.

A packet classifier within the packet switch 500 may define a SW T-port 504 according to the policy POL from the processor 16 shown in FIG. 1. Via the SW T-port 504, the T-port index PAC_IDX with a value “0” may be assigned to the packet PAC at an input port of the packet switch 500 (labeled as “PAC_IDX=0” in FIG. 5). The packet switch 500 may utilize multiple internal enqueue modules to perform packet forwarding upon the packet PAC between multiple hardware offload engines according to the T-port table 550 and the T-port index PAC_IDX with the value “0” (labeled as “Packet forwarding 508” in FIG. 5 for brevity), and output the packet PAC to an input port of the packet switch 502 after the packet forwarding process is completed.

A packet classifier within the packet switch 502 may also define a SW T-port 506 according to the policy POL from the processor 16 shown in FIG. 1. Via the SW T-port 506, the value of the T-port index PAC_IDX carried by the packet PAC may be changed from “0” to “2” (labeled as “PAC_IDX=2” in FIG. 5). The packet switch 502 may utilize multiple internal enqueue modules to perform packet forwarding upon the packet PAC between multiple hardware offload engines according to the T-port table 550 and the T-port index PAC_IDX with the value “2” (labeled as “Packet forwarding 510” in FIG. 5 for brevity), and output the final processed packet P_PAC after the packet forwarding process is completed. Since the operations and the architecture of each of the packet switches 500 and 502 are similar to that of the packet switch 20 shown in FIG. 2, further descriptions are not repeated in detail here for brevity.

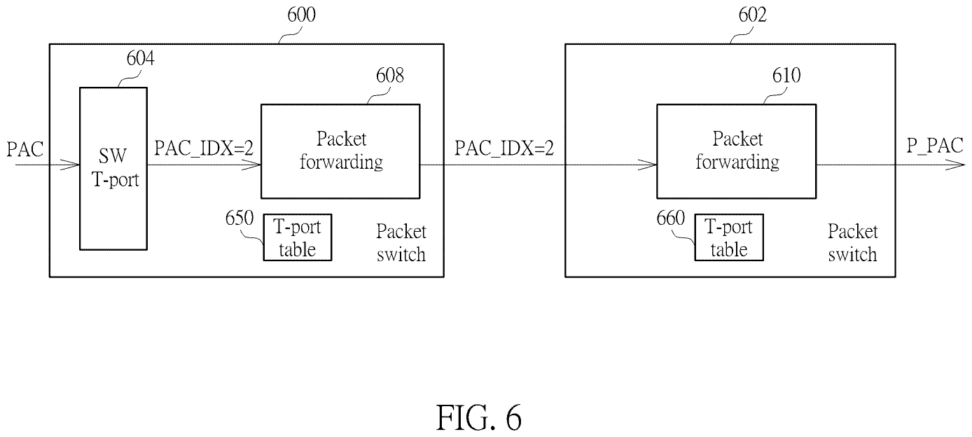

FIG. 6 is a diagram illustrating utilizing multiple packet switches 600 and 602 to perform packet forwarding according to another embodiment of the present invention, wherein each of the packet switches 600 and 602 may be implemented by the packet switches 20 shown in FIG. 2. In this embodiment, after the packet PAC is forwarded by the packet switch 600, the packet PAC is further forwarded by the packet switch 602 for outputting the final processed packet P_PAC via an output port of the packet switch 602. In addition, a T-port table 650 applied to the packet switches 600 is different from a T-port table 660 applied to the packet switch 602.

A packet classifier within the packet switch 600 may define a SW T-port 604 according to the policy POL from the processor 16 shown in FIG. 1. Via the SW T-port 604, the T-port index PAC_IDX with a value “2” may be assigned to the packet PAC at an input port of the packet switch 600 (labeled as “PAC_IDX=2” in FIG. 6). The packet switch 600 may utilize multiple internal enqueue modules to perform packet forwarding upon the packet PAC between multiple hardware offload engines according to the T-port table 650 and the T-port index PAC_IDX with the value “2” (labeled as “Packet forwarding 608” in FIG. 6 for brevity), and output the packet PAC to an input port of the packet switch 602 after the packet forwarding process is completed.

The packet switch 602 will not define an additional SW T-port, and may directly utilize multiple internal enqueue modules to perform packet forwarding upon the packet PAC between multiple hardware offload engines according to the T-port table 660 and the T-port index PAC_IDX with the value “2” (labeled as “Packet forwarding 610” in FIG. 6 for brevity), for outputting the final processed packet P_PAC after the packet forwarding process is completed. Since the operations and the architecture of each of the packet switches 600 and 602 are similar to that of the packet switch 20 shown in FIG. 2, further descriptions are not repeated in detail here for brevity.

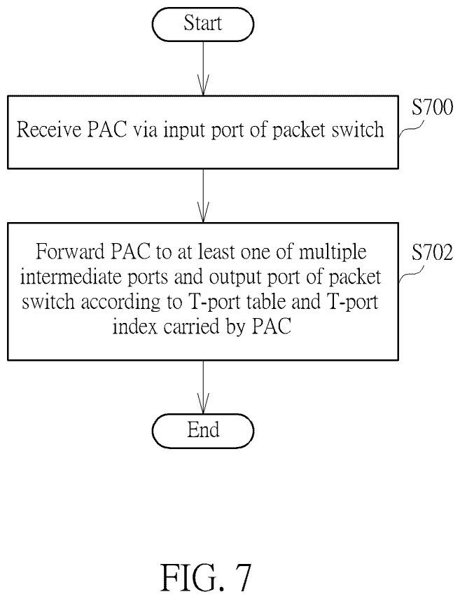

FIG. 7 is a flow chart of a packet forwarding method according to an embodiment of the present invention. Provided that the result is substantially the same, the steps are not required to be executed in the exact order shown in FIG. 7. For example, the packet forwarding method may be performed by the packet switch 20 shown in FIG. 2.

In Step S700, the packet PAC is received via an input port (e.g., the port P₀) of the packet switch 20.

In Step S702, by the enqueue modules 202_0-202_m of the packet switch 20, the packet PAC is forwarded to at least one of multiple intermediate ports (e.g., the ports P₁-Pₙ₋₁) and an output port (e.g., the port Pr) of the packet switch 20 according to the T-port table 206 and the T-port index PAC_IDX, wherein the packet PAC carries the T-port index PAC_IDX, and the enqueue modules 202_0-202_m correspond to the input port and the intermediate ports of the packet switch 20, respectively.

Since a person skilled in the pertinent art can readily understand details of the steps after reading above paragraphs, further description is omitted here for brevity.

In Summary, by the packet switch and the associated packet forwarding method proposed by the present invention, a T-port index can be assigned to a received packet via a software-defined T-port, and multiple enqueue modules can determine a forwarding path of the packet according to the T-port index and a T-port table, for performing necessary offloading processing. Compared to a pipeline-based offloading solution, the packet switch of the present invention can save the costs associated with additional MUX circuits, and can improve the latency issues caused by bypass paths.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet switch, comprising:
multiple ports, wherein the multiple ports comprise an input port, multiple intermediate ports, and an output port, and a packet is received via the input port; and
multiple enqueue modules, arranged to forward the packet to at least one of the multiple intermediate ports and the output port according to a through-port (T-port) table and a T-port index, wherein the packet carries the T-port index, and the multiple enqueue modules correspond to the input port and the multiple intermediate ports, respectively.

2. The packet switch of claim 1, wherein the packet switch further comprises a packet classifier, and the packet classifier is arranged to define at least one T-port according to a software-defined policy, and the T-port index is assigned to the packet via the at least one T-port.

3. The packet switch of claim 2, wherein the at least one T-port comprises a first T-port, and the first T-port is located at the input port for assigning a first value of the T-port index to the packet.

4. The packet switch of claim 3, wherein the at least one T-port further comprises a second T-port, the second T-port is located at one of the multiple intermediate ports for assigning a second value of the T-port index to the packet, and the second value is different from the first value.

5. The packet switch of claim 1, wherein the T-port table is comprised in the packet switch, and is shared with all of the multiple enqueue modules; and for any of the input port and the multiple intermediate ports, a mapping relationship between the T-port index and a next port where the packet is forwarded is recorded in the T-port table.

6. The packet switch of claim 1, wherein at least one of the multiple intermediate ports is coupled to at least one hardware offload engine.

7. The packet switch of claim 1, wherein the packet switch further comprises a packet switch buffer shared by at least one offload engine, and the at least one offload engine fetches and processes the packet in order to generate a processed packet, and returns the processed packet to the packet switch buffer.

8. The packet switch of claim 1, wherein the packet is further forwarded by another packet switch, and a same T-port table is shared between the packet switch and said another packet switch.

9. The packet switch of claim 1, wherein the packet is further forwarded by another packet switch, and the T-port table applied to the packet switch is different from a T-port table applied to said another packet switch.

10. A packet forwarding method, wherein the packet forwarding method is performed by a packet switch; the packet switch comprises multiple ports and multiple enqueue modules; the multiple ports comprise an input port, multiple intermediate ports, and an output port; the multiple enqueue modules correspond to the input port and the multiple intermediate ports, respectively; and the packet forwarding method comprises:
receiving a packet via the input port;
forwarding, by the multiple enqueue modules, the packet to at least one of the multiple intermediate ports and the output port according to a through-port (T-port) table and a T-port index, wherein the packet carries the T-port index.

11. The packet forwarding method of claim 10, wherein the packet switch further comprises a packet classifier, and the packet forwarding method further comprises:
defining, by the packet classifier, at least one T-port according to a software-defined policy, wherein the T-port index is assigned to the packet via the at least one T-port.

12. The packet forwarding method of claim 11, wherein the at least one T-port comprises a first T-port, and the first T-port is located at the input port for assigning a first value of the T-port index to the packet.

13. The packet forwarding method of claim 12, wherein the at least one T-port further comprises a second T-port, the second T-port is located at one of the multiple intermediate ports for assigning a second value of the T-port index to the packet, and the second value is different from the first value.

14. The packet forwarding method of claim 10, wherein the T-port table is comprised in the packet switch, and is shared with all of the multiple enqueue modules; and for any of the input port and the multiple intermediate ports, a mapping relationship between the T-port index and a next port where the packet is forwarded is recorded in the T-port table.

15. The packet forwarding method of claim 10, wherein at least one of the multiple intermediate ports is coupled to at least one hardware offload engine.

16. The packet forwarding method of claim 10, wherein the packet switch further comprises a packet switch buffer shared by at least one offload engine, and the at least one offload engine fetches and processes the packet in order to generate a processed packet, and returns the processed packet to the packet switch buffer.

17. The packet forwarding method of claim 10, wherein the packet is further forwarded by another packet switch, and a same T-port table is shared between the packet switch and said another packet switch.

18. The packet forwarding method of claim 10, wherein the packet is further forwarded by another packet switch, and the T-port table applied to the packet switch is different from a T-port table applied to said another packet switch.
